(19) United States
(12) Patent Application Publication
(10) Pub. No.: US 2024/0411585 A1
(43) Pub. Date: Dec. 12, 2024

(54) LIFECYCLE ORCHESTRATION

(71) Applicant: Capital One Services, LLC, McLean, VA (US)

(72) Inventors: Sean Francis JEPSON, Richmond, VA (US); Charles Wellum HALL, Manakin-Sabot, VA (US); Anirban BANERJEE, Richmond, VA (US); Akash VERMA, Henrico, VA (US)

(73) Assignee: Capital One Services, LLC, McLean, VA (US)

(21) Appl. No.: 18/208,786

(22) Filed: Jun. 12, 2023

(51) Int. Cl. G06F 9/48; G06F 9/455

(52) U.S. Cl. CPC G06F 9/48; G06F 9/45558

(57) ABSTRACT

A method, a system, and a computer program product for lifecycle orchestration. An input computing event generated by a computing application executing in a computing system is received. A plurality of tasks associated with the input computing event is determined. A process flow is selected from a plurality of process flows based on one or more models defining one or more states of the computing system during execution of each process flow and a plurality of executable actions for performing tasks. At least one executable action for performing at least one task is executed resulting in the computing system being transferred from one state to another. An output computing event resulting from the executing of the executable action is generated. While the computing system is in another state, another executable action for performing another task is executed, where the generated output computing event is input to the executing of another executable action.

### TECHNICAL FIELD

This disclosure relates generally to data processing and, in particular, to operation, running, and/or lifecycle of various processes in computing systems.

### BACKGROUND

Computing systems provide an ability to execute various computing processes that may be associated with one or more software applications integrated into and/or with the computing systems. Software applications may be used for resolving various problems, issues, etc. that may be received by the applications. Currently, each software application defines its own processes for such resolution. However, there is a lack of a centralized system that may incorporate various process flows, which may in turn, be obtained from separate sources, for addressing such problems, issues, etc. and perform a lifecycle orchestration execution and monitoring associated therewith.

### SUMMARY

In some implementations, the current subject matter relates to a computer-implemented method for orchestrating execution of one or more or multiple computing processes or stages or groups thereof as well as one or more transitions between such processes or stages or groups thereof. The method may include receiving, using at least one processor, an input computing event generated by at least one computing application executing in a computing system, determining a plurality of tasks associated with the received input computing event, and selecting a process flow in a plurality of process flows. The selection may be based on one or more models generated for execution of each process flow in the plurality of process flows. The models may define one or more states of the computing system during execution of each process flow in the plurality of process flows and a plurality of executable actions for performing one or more tasks in the plurality of determined tasks. Each process flow in the plurality of process flows may be generated by at least one federated data source in a plurality of federated data sources. The method may also include executing at least one executable action in the plurality of executable actions for performing at least one task in the plurality of determined tasks. Execution of at least one executable action transferring the computing system from at least one state in one or more states to at least another state in one or more states.

In some implementations, the current subject matter may be configured to include one or more optional features. The method may also include generating an output computing event in a plurality of output computing events resulting from the executing of the executable action, and executing, while the computing system in at least another state, at least another executable action in the plurality of executable actions for performing at least another task in the plurality of determined tasks. The generated output computing event may be input to the executing of at least another executable action.

In some implementations, the method may include receiving data from at least one database communicatively coupled with the computing system and associated with the executing of at least one executable action, and updating the generated output computing event using the received data to generate an updated generated output computing event. The updated generated output computing event may be input to the executing of at least another executable action.

In some implementations, executing at least one executable action may include executing at least one executable action after a first predetermined period of time. Further, executing at least another executable action may include executing at least another executable action after a second predetermined period of time, where the second predetermined period of time may be different from the first predetermined period of time.

In some implementations, executing at least one executable action may include preventing executing of at least one executable action after a first predetermined period of time.

In some implementations, the method may also include executing each executable action in the plurality of executable actions in a sequential order to perform all determined tasks in the plurality of determined tasks. An output computing event generated by executing of each executable action may be input to each subsequent executable action in the plurality of executable actions.

In some implementations, each federated data source in the plurality of federated data sources may be separate from other federated data sources in the plurality of federated data sources. Each executable action may be executed using a separate container in a plurality of containers.

In some implementations, each state may be associated with execution of one or more microservices corresponding to executing of one or more executable actions in the plurality of executable actions. Execution of one or more microservices may generate one or more output computing events in the plurality of output computing events. One or more output computing events may be generated using at least one of the following: synchronous generation, asynchronous generation, and any combination thereof.

In some implementations, the computing system may be a multi-tenant computing system having a plurality of tenant computing systems. One or more executable actions may be configured for executing for all tenant computing systems in the plurality of tenant computing systems. Further, one or more first executable actions may be configured for executing for first tenant computing systems in the plurality of tenant computing systems. One or more second executable actions may be configured for executing for second tenant computing systems in the plurality of tenant computing systems. The first executable actions may be different from the second executable actions.

In some implementations, the method may also include generating a user interface associated with at least one of the following: the executing of one or more executable actions in the plurality of executable actions, displaying one or more output computing events in the plurality of output computing events, selecting of one or more process flows in the plurality of process flows, altering one or more process flows in the plurality of process flows, and any combination thereof.

In some implementations, the current subject matter relates to a system for lifecycle orchestration. The system may include at least one processor, and at least one non-transitory storage media storing instructions, that when executed by the processor, cause the processor to perform operations including determining a plurality of tasks associated with an input computing event generated by at least one computing application executing in a computing system, and generating a model for executing of a process flow in a plurality of process flows. The model may define one or more states of the computing system during execution of the process flow and a plurality of executable actions for performing one or more tasks in the plurality of determined tasks. The operations may also include transferring the computing system from at least one state in one or more states to at least another state in one or more states during execution of at least one executable action in the plurality of executable actions, generating, based on the transferring, an output computing event in a plurality of output computing events resulting from the executing of at least one executable action, and executing, while the computing system in at least another state, at least another executable action in the plurality of executable actions for performing at least another task in the plurality of determined tasks. The generated output computing event may be input to the executing of at least another executable action.

In some implementations, the current subject matter may include one or more of the following optional features. Each process flow in the plurality of process flows may be generated by at least one federated data source in a plurality of federated data sources. Each federated data source in the plurality of federated data sources may be separate from other federated data sources in the plurality of federated data sources. Each executable action in the plurality of executable actions may be executed using a separate container in a plurality of containers.

In some implementations, the operations may also include receiving data from at least one database communicatively coupled with the computing system and associated with the executing of at least one executable action, and updating the generated output computing event using the received data to generate an updated generated output computing event. The updated generated output computing event may be input to the executing of at least another executable action.

In some implementations, each state in one or more states may be associated with execution of one or more microservices corresponding to the executing of one or more executable actions in the plurality of executable actions. The execution of microservices may generate one or more output computing events in the plurality of output computing events. One or more output computing events may be generated using at least one of the following: synchronous generation, asynchronous generation, and any combination thereof.

In some implementations, the current subject matter relates to at least one non-transitory storage media for lifecycle orchestration, where the media may store instructions that, when executed by at least one processor, cause the processor to perform operations including generating a model for executing of a process flow in a plurality of process flows. The model may define one or more states of a computing system during execution of the process flow and a plurality of executable actions for performing one or more tasks in a plurality of determined tasks. Each state in one or more states may be associated with execution of one or more microservices corresponding to executing of one or more executable actions in the plurality of executable actions. The execution of one or more microservices generate one or more output computing events in a plurality of output computing events. The operations may also include transferring the computing system from at least one state in one or more states to at least another state in one or more states during execution of at least one executable action in the plurality of executable actions, generating one or more output computing events, and executing, while the computing system in at least another state, at least another executable action in the plurality of executable actions for performing at least another task in the plurality of determined tasks. The generated output computing event may be input to executing of at least another executable action.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors, such as, within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1a illustrates an exemplary lifecycle orchestration system, according to some implementations of the current subject matter;

FIG. 1b illustrates an exemplary lifecycle orchestration system, according to some implementations of the current subject matter;

FIG. 2 illustrates an exemplary lifecycle orchestration process, according to some implementations of the current subject matter;

FIG. 3 illustrates an exemplary lifecycle orchestration process, according to some implementations of the current subject matter;

FIG. 4 illustrates yet another exemplary lifecycle orchestration process, according to some implementations of the current subject matter; and

FIG. 5 illustrates an exemplary computer architecture, according to some implementations of the current subject matter.

### DETAILED DESCRIPTION

To address these and potentially other deficiencies of currently available solutions, one or more implementations of the current subject matter relate to methods, systems, articles of manufacture, and the like that can, among other possible advantages, provide centralized lifecycle orchestration management of process flows in computing systems.

In some implementations, the current subject matter generally relates to coordinating execution of various computing processes or groups of such processes in a computing system, where execution of each process may be associated with execution of a particular associated process flow that enables transitioning the computing system from one state to another. These may include execution of one or more microservices, routines, functions, etc. Each state of the computing system may be defined by one or more models, where each model defines one or more executable actions for transitioning the computing system between different states. Execution of the computing processes may be triggered using an input computing event that may be generated by a computing application being executed in the computing system. Moreover, each process flow may be developed by separate and/or federated data sources and may be provided to the computing system for execution. The computing system may be a multi-tenant computing system, where each tenant may be associated with one or more specific process flows that may be unique to that tenant and/or common process flows that may be common to all tenants.

In some implementations, coordination of execution of various computing events may be referred to as a lifecycle. During such lifecycle, the system may be designed to receive an input computing event (e.g., a query to retrieve data; a computing prompt indicating that execution of a particular computing call, function, routine, and/or procedure may be desired and/or needed; an application programming interface (API) call, function, routine, and/or procedure; a hypertext transfer protocol/secure (HTTP/HTTPS) communication; a representation state transfer (REST) communication; a session description protocol (SDP) communication; a JAVASCRIPT output, file, etc.; a JSON document, file, etc.; a graphical user interface input; a text input; a graphical input; an audio input; a video input; and/or any other communication, input, call, function, routine, procedure, etc.) a request from a customer to address potential fraud, to resolve transaction issues, etc.), select existing process flow(s) and/or generate specific process flow(s), and initiate process flow(s) execution. Each process flow may receive one or more output(s) of any previously executed process flows as well as any other input data (e.g., newly received inputs). The system may monitor each process and/or state of the system during lifecycle and may continue its execution until resolution of all processes is achieved.

A non-limiting example of a process flow may include set(s), phase(s), stage(s), etc. of instructions, computing operations, functions, procedures, calls, APIs, and/or any other operations that may be performed in connection with a request that may be received. For example, a fraud resolution request (e.g., in connection with a fraudulent charge on a customer's credit card account) may be received from a customer of a banking system. Upon receiving of such request (which may be an example of an input computing event), a case creation phase may be initiated, during which the request may be analyzed (e.g., using a letter received from a customer relating to the request) and an investigation case may be created. The case may be associated with various supporting materials and/or documentation, e.g., letter corresponding to customer's request, evidentiary documents (e.g., listing of charges, customer's statements, etc.). Once the case is created, the current subject matter may be configured to execute a case resolution phase of the process flow. The case resolution phase may involve gathering various information related to the customer, the request, etc. and performing analysis of the gathered information. Various calls, procedures, requests, documents, outputs, etc. (e.g., seeking more information, data, etc.) may be generated (which may be an example of an output computing event) and forwarded to subsequent phase(s). Each time such output computing events are generated, the current subject matter's system may be configured to enter into one or more states. For example, in connection with fraud resolution, one state may include “waiting for more information”, another may be “executing next routine in fraud resolution”, etc. One or more output computing events may be input to one or more next phases of the process flow (e.g., receipt of additional documentation may be an input to additional analysis phase, etc.). The current subject matter system may be configured to continue execution (e.g., corresponding to a lifecycle) of the different phases until a final output (e.g., resolution of a fraud investigation) is reached. Each phase of the above process may be defined by one or more model that may outline which phases may need to be executed, what data may need to be obtained, etc. The process flows, models, etc. may be generated by various computing sources (e.g., developer(s) of computing systems designed to address specific issues (e.g., fraud resolution)). As can be understood, the above discussion presents a non-limiting example of an implementation of current subject matter's system. Other implementations and/or uses are possible.

In some example implementations, the input computing event may be generated by at least one computing application executing in the computing system. The current subject matter system may be configured to determine a plurality of tasks that may be associated with the received input computing event. As stated above, one or more process flows (e.g., in a plurality of process flows) may be selected. The selection may include generation of one or more models for execution of each process flow (e.g., in the plurality of process flows). The models may be configured to define one or more states of the computing system during execution of each process flow. Alternatively, or in addition, one or more (and/or a plurality of) executable actions for performing one or more tasks may be defined. Each process flow may be generated by at least one federated data source (which, for example, may include, but are not limited to, one or more computing processors and/or systems, one or more developers and/or any other entities). A plurality of federated data sources may exist and may be configured to generate process flows.

Once the executable actions are defined and/or generated, such actions may be executed to perform one or more tasks (which may have been previously determined and/or dynamically defined). Execution of the actions may involve a transfer of the computing system from at least one state (e.g., a first state) to at least another state (e.g., a second state).

In some implementations, each execution of the actions may result in generation of one or more output computing event(s) (e.g., a query to retrieve data; a computing prompt indicating that execution of a particular computing call, function, routine, and/or procedure may be desired and/or needed; an application programming interface (API) call, function, routine, and/or procedure; a hypertext transfer protocol/secure (HTTP/HTTPS) communication; a representation state transfer (REST) communication; a session description protocol (SDP) communication; a JAVASCRIPT output, file, etc.; a JSON document, file, etc.; a graphical user interface output; a text output; a graphical output; an audio output; a video output; and/or any other communication, output, call, function, routine, procedure, etc.). The generated output computing event(s) may be subsequently used by the computing system. For example, while the computing system is in the second state, one or more other executable actions (e.g., that may be configured to perform one or more other computing task(s)), the previously generated output computing event may be used as an input to execution of such other executable action(s).

In some implementations, the current subject matter may be configured to receive data from at least one database. The data may be received as a result of a query that may be issued during execution of the actions and/or in any other way. The database may be communicatively coupled to the computing system. In some example, non-limiting implementations, the database may be specifically associated with the execution of a particular action. The data may be used to update the previously generated output computing event to generate an updated generated output computing event. Such updated output computing event may be used as an input to execution of another executable action.

In some implementations, execution of actions may include execution of actions after predetermined periods of time. For example, a certain period of time may be configured to pass before an action can be executed. Any subsequent actions may also be associated with such predetermined “wait-to-execute” periods of time. Each such period of time may be same and/or different from other periods of time.

In some example, non-limiting implementations, the process of execution of actions may involve preventing execution of actions after a predetermined of time. For example, a specific action is designed to be executed within a predetermined period of time. Once that period of time expires, execution of the action may no longer be permitted. For example, execution of an action may have relied on a time-sensitive data that may be valid during a certain period of time. After expiration of such period of time, execution of that action would not be viable and/or would not produce any meaningful results, and hence, the execution process may be aborted and/or not go forward.

In some implementations, actions may be executed in a sequential order, such as for example, to perform all determined tasks in a particular order. An output computing event generated by the execution of each executable action may be configured to be input to each subsequent executable action and/or any other of the executable actions.

In some implementations, each federated data source that generates process flows may be separate from other federated data sources (e.g., separate computing system(s) and/or developer(s) may be configured to be separate from one another and generate/create their own process flows). Moreover, each executable action may be executed using a separate container that may be associated with one or more federated data sources (e.g., each action, which may be part of a particular process flow, may be executed and/or executable using one or more computing environments, packages, systems, etc. that may include necessary elements for such executions).

In some implementations, each state of the computing system may be associated with execution of one or more microservices corresponding to execution of one or more executable actions. Execution of the microservices may be configured to generate one or more output computing events. For example, the output computing events may be generated using at least one of the following: synchronous generation, asynchronous generation, and any combination thereof.

In some example, non-limiting implementations, the computing system may be a multi-tenant computing system that may include a plurality of tenant computing systems. The executable actions may be configured for execution for all tenant computing systems in such plurality of tenant computing systems. In some implementations, execution of actions may be divided among tenant computing systems. For example, one or more first executable actions may be configured for execution for one or more first tenant computing systems, and one or more second executable actions may be configured for execution for one or more second tenant computing systems. The first executable actions may be same and/or different from the second executable actions.

In some implementations, the current subject matter may be configured to generate a user interface for controlling execution of executable actions. The user interface may be configured to display the output computing events resulting from execution of the actions.

In some implementations, the current subject matter may be configured to define process workflows that may represent computing system and/or any other types of process flows. By way of a non-limiting example, the current subject matter may be configured to orchestrate a variety of computing processes, such as, a running process (e.g., a case) across a series of automated microservices (e.g., including user interactions). Such process flows may also provide an ability to visualize the process flow using one or more state machine diagrams (e.g., state charts, state transition diagrams, etc.). The lifecycle orchestration service may be configured to allow various users to publish process flows, e.g., defined as a state machine diagram, without the need for downtime. Each user may own and/or manage any number of versions of their process flows and publish them when they want with no downtime to the service. The lifecycle orchestration service may be centrally located and/or managed so that federated users do not have to own the infrastructure on which they publish their process flows. Flow visualization may be provided, which may enable entities to easily visualize and understand the process flows.

In some implementations, a running process in a computing system or a case may refer to a logical construct and/or container that may encapsulate various complex computing interactions and/or automated work from start to finish, to deliver and execute an intended process outcome based off of a receive input (e.g., a query from a user), while handling any exceptions encountered along the way. A task may refer to a computing process function that may need to be accomplished within a particular process. A lifecycle definition may refer to a file that may represent a process flow as a state chart diagram. For example, a state chart diagram may refer to a process flow (e.g., a JAVASCRIPT file) that may include a document (e.g., a JSON document) describing a state chart, and where any definitions may be rendered as a visual diagram. It may describe a flow of control from one state to another state of the computing system where processes are executed. States may be defined as a point during execution of a process that is ready to receive new events, data, etc. and/or perform some action. A state chart diagram may be generated from a workflow definition to present a model of a lifetime of a process from creation to termination and declare one or more events it responds to with resulting actions at various moments in the lifetime of a process. A flowchart may be similar to a state diagram, where a flowchart may document a set of logical steps and decisions along a timeline. A state diagram may be configured to document various states in which a computing system may exist and the triggers and transitions between them. A lifecycle service may be configured to orchestrate tasks across all services (e.g., process execution, data retrieval, discovery, communications, etc. during execution of the process).

While the current subject matter may be used in orchestrating lifecycle(s) of various computing processes, it may also be used for the purposes of fraud resolution, error-handling, and any other types of business interactions. For example, the current subject matter system may be used by a financial institution to resolve a fraudulent transaction. Upon receiving a query from a user (e.g., a call from a customer), the financial institution may generate a case. The case may be an “envelope” that may encompass various interactions, e.g., manual and/or automated, that may be required to resolve/fulfill the query. This may generate an audit/approval trail of all actions and interactions execute to resolve the query. There are multiple ways and/or “channels” using which a new case may be created. For example, a case may be created when a customer calls in to report fraud on their account. The case may be created to conduct a research on the account's transactions.

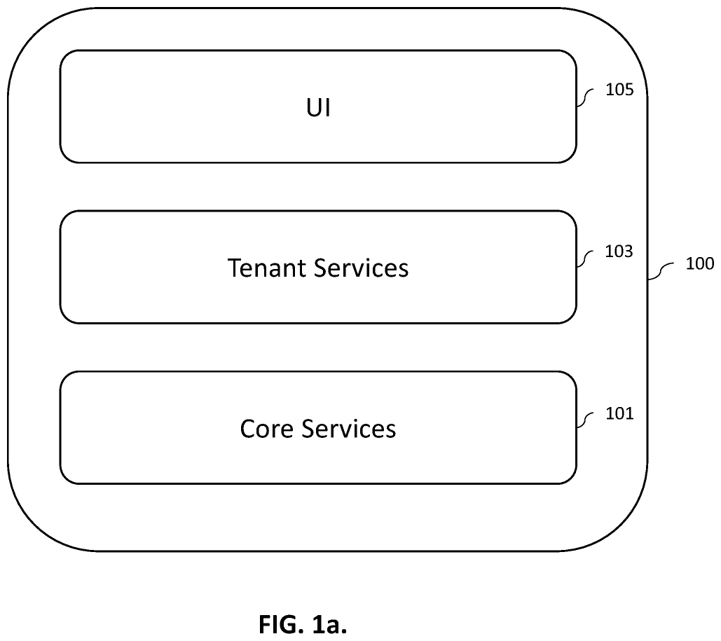

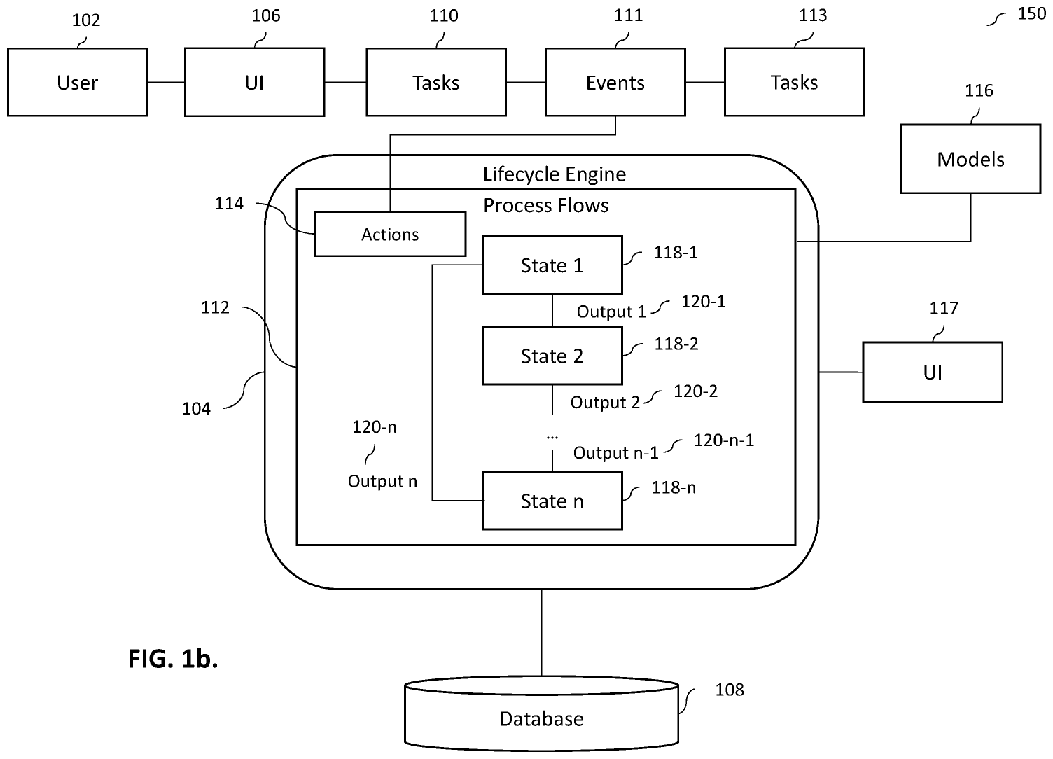

FIG. 1a illustrates an exemplary lifecycle orchestration system 100, according to some implementations of the current subject matter. The system 100 may include one or more of the following logical layers—core service(s) and/or component(s) (used interchangeably herein) 101, tenant service(s) and/or component(s) 103, and user interface(s) and/or component(s) 105. The services 101-105 may be communicatively coupled using one or more communications networks. The communications networks may include one or more of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

Further, services 101-105 may include any combination of hardware and/or software. In some implementations, services 101-105 may be disposed on one or more computing devices, such as, server(s), database(s), personal computer(s), laptop(s), cellular telephone(s), smartphone(s), tablet computer(s), and/or any other computing devices and/or any combination thereof. In some example implementations, services 101-105 may be disposed on a single computing device and/or may be part of a single communications network. Alternatively, or in addition to, such services may be separately located from one another. A service may be a computing processor, a memory, a software functionality, a routine, a procedure, a call, and/or any combination thereof that may be configured to execute a particular function associated with the current subject matter lifecycle orchestration service(s).

In some implementations, the core service(s) 101 may provide a set of common capabilities of case management systems. The core service(s) may include, for example, case service(s), lifecycle service(s), task service(s), correspondence service(s), document management service(s) (DMS), discovery service(s), activity log service(s), and physical tracker service(s).

The case service(s) may be responsible for creating the case, a logical container/envelope for all data and actions associated with the case process/resolution. A case identifier (ID) may be generated upon creating a case. The case ID may be used to attach pertinent information required for resolution of the case. The case service(s) may signal to the lifecycle service(s) that a new case and the corresponding process flow may be started for the case type.

The lifecycle service(s) may refer to a process engine (e.g., as shown in FIG. 1b) that may be used to execute the defined case flow to a completion. Flows may be defined as state diagrams (e.g., lifecycle definitions) and may be published to the lifecycle service(s) and associated with a tenant, a case type, case subtype, and/or any other information. When a case is created, e.g., via the case service(s), the associated lifecycle definition(s) may be used to orchestrate various core and/or tenant microservices to perform various tasks, actions, functionalities, etc. associated with resolution of the case.

The task service(s) may be responsible for managing various tasks (e.g., which may include manual and/or automated tasks) created by either the lifecycle service(s) and/or tenant service(s) and distributing them to the client UI(s) for interaction/resolution. It may act as a bridge between various (e.g., automated and/or manual) steps in the process flow. Tasks may be executed as part of a process flow that may require research and/or approval. The task service(s) may ensure that the outstanding tasks are distributed in the correct priority for execution. The task service(s) may also be responsible for managing any pending and/or expiring of tasks. Some tasks (e.g., automated and/or manual) may correspond to events that may trigger one or more microservices for performing one or more actions associated with one or more process flows and/or one or more actions in a process flow. In some implementations, a timer service(s) may be used to handle one or more timers associated with execution of one or more actions in a process flow and/or generate one or more timeout events that may indicate that one or more timers associated with one or more actions in a process flow have expired.

The correspondence service(s), which may correspond to one or more microservices, may be responsible, for example, for sending outbound letters to users. These letters may be generated from letter templates using input provided from the calling client. Templates may be configured and/or associated for use with tenant/case type/case subtype flows, etc. In some example, non-limiting implementations, the current subject matter may include one or more document service(s) that may be responsible for inbound correspondence from users and/or creating a new case and/or matching the document with an existing case. The discovery service(s) may be responsible for attaching relevant data/information to the case. The activity log service(s) may be responsible for keeping an audit history of all the significant actions performed, manually and/or automated during the case resolution process. The activity log may be exposed in the UI and used to understand the history of the case. Additionally, activity messages may be tagged for UI display and/or kept out of the UI and used for future analysis. The case progress tracker service(s) may be responsible for maintaining the key steps/gates in the resolution of a case. They may provide data for visual representation of where in the process flow a case stands. It may capture key case process flow steps and current case status.

In some implementations, the system 100 may be configured as a multi-tenant computing platform or architecture. With a multi-tenant architecture, the platform and its services 101-105 may be configured to provide every tenant a dedicated share of service(s) instances, which may include, but not limited to, data, configuration, user management, tenant individual functionality, non-functional properties, etc. Multi-tenant architecture may be different from multi-instance architectures, where separate software instances may be configured to operate on behalf of different tenants. A tenant on the system 100 may be configured as a computing system and/or functionality that may have users that share common access (e.g., with specific privileges) to the platform. The tenant service(s) 103 may be configured to include transaction trouble service(s), standard case service(s), lifecycle and workflow service(s) (e.g., service member civil relief act (SCRA), credit bureau dispute (CBD), etc.), security service(s), open policy agent service(s), single sign on (SSO) service(s), and/or any other service(s).

The transaction trouble service(s) may be configured to handle various functionalities. In the financial institution context these may be used to handle fraud, as it pertains to various fraud and disputes claims, where flows dealing with chargebacks, merchant credits, financial adjustments, and write-offs may be handled by these service(s). Standard case service(s) may reference a set of tenants that leverage the standard services and UI patterns (in the UI service(s) 105) provided by the common case/universal UI and the lifecycle service to address standard cases. The lifecycle and/or workflow service(s) may be configured to define various lifecycle and UI workflows that may implement standard case service(s) to resolve various issues. The security service(s) provide various security, authentication, identification, etc. services that may be associated with system 100 services and workflows. Open policy agent service(s) may be used for generation of security policies/rules used for securing access to the tenant and platform services. SSO service(s) may provide authentication and/or authorization service(s) for the tenants in the system 100, where SSO service(s) may be triggered upon execution of one or more user interfaces, and thus, may be associated with one or more frontend components of the current subject matter system. Application programming interfaces of various other services (e.g., task, case, etc. services) may rely on various secure connections to provide authentication/authorization.

In some implementations, the current subject matter system may be configured to include a plurality of microservices that may execute one or more atomic actions associated with a case solution. For example, the microservices may include a case, task, and lifecycle microservices. The case microservice may manage creation, retrieval, and/or attaching of data to a container associated with a particular case. The task microservice may track and/or prioritize interactions that may be required by a case. The lifecycle microservice may orchestrates all system interactions needed to resolve the case.

FIG. 1b illustrates an exemplary lifecycle orchestration system 150, according to some implementations of the current subject matter. The system 150 may be configured to be incorporated into one or more components 101-105 of the system 100 shown in FIG. 1a. The system 150 may be configured to include a lifecycle engine 104 including one or more process flows components 112 having one or more actions components 114, one user interface(s) 106 that may be accessible by one or more users 102, one or more databases 108, one or more task components 110, one or more event components 111, one or more task components 113, one or more models components 116, and one or more user interface components 117 (which may be accessible by one or more development/support users). At least one or more of the components 104-117 may be executable and/or executed using one or more microservices and/or any other computing processes/processors.

The components 104-117 may include any combination of hardware and/or software. In some implementations, components 104-117 may be disposed on one or more computing devices, such as, server(s), database(s), personal computer(s), laptop(s), cellular telephone(s), smartphone(s), tablet computer(s), and/or any other computing devices and/or any combination thereof. In some example implementations, components 104-117 may be disposed on a single computing device and/or may be part of a single communications network. Alternatively, or in addition to, such components may be separately located from one another. A component may be a computing processor, a memory, a software functionality, a routine, a procedure, a call, and/or any combination thereof that may be configured to execute a particular function associated with the current subject matter's lifecycle orchestration.

In some implementations, the system 100's components, including the user device 102, may include network-enabled computers. As referred to herein, a network-enabled computer may include, but is not limited to a computer device, or communications device including, e.g., a server, a network appliance, a personal computer, a workstation, a phone, a smartphone, a handheld PC, a personal digital assistant, a thin client, a fat client, an Internet browser, or other device. The components of the system 100 also may be mobile computing devices, for example, an iPhone, iPod, iPad from Apple® and/or any other suitable device running Apple's iOS® operating system, any device running Microsoft's Windows®. Mobile operating system, any device running Google's Android® operating system, and/or any other suitable mobile computing device, such as a smartphone, a tablet, or like wearable mobile device.

The components of the system 100 may include a processor and a memory, and it is understood that the processing circuitry may contain additional components, including processors, memories, error and parity/CRC checkers, data encoders, anti-collision algorithms, controllers, command decoders, security primitives and tamper-proofing hardware, as necessary to perform the functions described herein. The components of the system 100 may further include one or more displays and/or one or more input devices. The displays may be any type of devices for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some example implementations, the components of the system 100 may execute one or more applications, such as software applications, that enable, for example, network communications with one or more components of system 100 and transmit and/or receive data.

The components of the system 100 may include and/or be in communication with one or more servers via one or more networks and may operate as a respective front-end to back-end pair with one or more servers. The components of the system 100 may transmit, for example from a mobile device application (e.g., executing on one or more user devices, components, etc.), one or more requests to one or more servers. The requests may be associated with retrieving data from servers. The servers may receive the requests from the components of the system 100. Based on the requests, servers may be configured to retrieve the requested data from one or more databases (e.g., database 108 as shown in FIG. 1b). Based on receipt of the requested data from the databases, the servers may be configured to transmit the received data to one or more components of the system 100, where the received data may be responsive to one or more requests.

The system 100 may include one or more networks. In some examples, networks may be one or more of a wireless network, a wired network or any combination of wireless network and wired network and may be configured to connect the components of the system 100 and/or the components of the system 100 to one or more servers. For example, the networks may include one or more of a fiber optics network, a passive optical network, a cable network, an Internet network, a satellite network, a wireless local area network (LAN), a metropolitan area network (MAN), a wide area network (WAN), a virtual local area network (VLAN), an extranet, an intranet, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or any other type of network and/or any combination thereof.

In addition, the networks may include, without limitation, telephone lines, fiber optics, IEEE Ethernet 802.3, a wide area network, a wireless personal area network, a LAN, or a global network such as the Internet. Further, the networks may support an Internet network, a wireless communication network, a cellular network, or the like, or any combination thereof. The networks may further include one network, or any number of the exemplary types of networks mentioned above, operating as a stand-alone network or in cooperation with each other. The networks may utilize one or more protocols of one or more network elements to which they are communicatively coupled. The networks may translate to or from other protocols to one or more protocols of network devices. The networks may include a plurality of interconnected networks, such as, for example, the Internet, a service provider's network, a cable television network, corporate networks, such as credit card association networks, and home networks.

The system 100 may include one or more servers, which may include one or more processors that may be coupled to memory. Servers may be configured as a central system, server or platform to control and call various data at different times to execute a plurality of workflow actions. Servers may be configured to connect to the one or more databases. Servers may be incorporated into and/or communicatively coupled to at least one the components of the system 100.

As shown in FIG. 1b, the user device 102 may be configured to trigger operation of the lifecycle orchestration system 150. The user device 102 may do so by submitting a query, a request, etc. For example, the query, request, etc. may be related to a particular issue (e.g., fraud resolution, transaction issue, etc.). Based on the received query, request, etc., one or more task components 110 may be configured to generate an input computing event that may be provided to the lifecycle engine 104 via one or more event components 111. Some examples of input computing events may include, but are not limited to, a query to retrieve data; a computing prompt indicating that execution of a particular computing call, function, routine, and/or procedure may be desired and/or needed; an application programming interface (API) call, function, routine, and/or procedure; a hypertext transfer protocol/secure (HTTP/HTTPS) communication; a representation state transfer (REST) communication; a session description protocol (SDP) communication; a JAVASCRIPT output, file, etc.; a JSON document, file, etc.; a graphical user interface input; a text input; a graphical input; an audio input; a video input; and/or any other communication, input, call, function, routine, procedure, etc., and/or any combinations thereof. Various other tasks (e.g., automated tasks) may be generated by one or more task components 113 based on the received query, request, etc. and provided to the lifecycle engine 104. The tasks, events, etc. generated by the task components 110, 113 and/or event components 111 may be specific to a particular query, request, etc. as well as particular applications, systems, tenant computing systems (that may be communicatively coupled to and/or implementing the current subject matter system) preferences, needs, parameters, etc. One or more of the components that may be involved in creation and providing of events to lifecycle engine 104 may be executed using one or more microservices.

Upon receiving the input computing event from the event component(s) 111, the engine 104 may be configured to determine one or more actions 114 associated with one or more tasks that may be necessary for execution of one or more processes associated with the received input computing event. By way of a non-limiting example, the input computing event may be associated with a fraudulent activity received on a financial institution's customer's account. The tasks may involve obtaining information related to the customer, the customer account, execution of various procedures associated with resolution of the issue (e.g., preventing further activities on the customer account, etc.).

The tasks may trigger determination of all actions that may be required for execution based on the received input computing event and/or one or some such actions. In some implementations, the system 150 may be configured to determine which tasks may be required for resolution of the issues associated with the received input computing event. Further, the engine 104 may be configured to generate one or more tasks depending on the received input computing event. The component 110 may be configured to store one or more such tasks and/or may be used by the engine 104 for generation of one or more tasks in connection with the received input computing event.

The engine 104 may also access the component 112 to select one or more process flows having one or more actions 114 that may be executed during execution of a process pipeline that may be used for resolution of the issues associated with the input computing event. As part of the process flows selection, the engine 104 may be configured to execute process flows in accordance with one or more models that may be provided by models component 116. The models 116 may be used to define one or more states (118-1)-(118-n) of the computing system 150 during execution of each process flow in the selected process flows as well as corresponding executable actions 114. The actions 114 may be executed in connection with performing determined tasks in the plurality of determined tasks. In some implementations, each process flow contained in the component 112 may be developed and/or defined by one or more separate federated data sources. For example, federated data sources may include developers that may design, implement, compile, test, etc. a particular computing code for execution of each process flow. Upon completion of such code, the federated data sources may transmit the computing code to the component 112 for use during execution by the lifecycle engine 104 for resolution of various scenarios. One of the advantages of this arrangement includes a centralized location of process flows and immediate availability for selection by the engine 104. This substantially reduces time of execution by the engine 104, total cost of ownership, and operational errors.

Once the process flows and corresponding actions have been selected and/or identified by the engine 104, the engine 104 may be configured to execute one or more of the actions. In some example, non-limiting, implementations, the engine 104 may also be configured to access the database 108 and retrieve various data that may be needed for execution of a particular action and/or group of actions. The data accessing may be performed either before, during and/or after identification/determination of tasks, process flows, actions, etc. and/or execution of such. Moreover, the engine 104 may be configured to store and/or persist one or more states, including, any initial, intermediate and/or final states associated with one or more process flows. Execution of an action by the engine 104 may be configured to perform one or more determined tasks. In some implementations, the engine 104 may be configured to generate one or more actions, which may, in turn, generate one or more events. Generation of such event(s) may trigger execution of one or more microservices associated with and/or communicatively coupled to one or more components of the system 150. The microservice(s) may access the database 108 and retrieve data that may be used by the engine 104 during execution of process flows.

The execution of actions may also transition the system 150 from one state (e.g., state 118-1) to another state (e.g., state 118-2). Each state 118 may be configured to be associated with a particular state of execution of the process flow, where during each such state, the engine 104 may be configured to respond to one or more input computing events that may be associated with one or more defined actions 114. Actions may be executed using one or more microservices configured to perform various tasks associated with one or more actions (e.g., trigger a document service to send a letter to a customer, generate a user interface for a user to complete a particular form, etc.). The microservices may be configured to generate one or more events 120 either synchronously, asynchronously, and/or in any other fashion.

Each and/or all state(s) 118 may also be defined by one or more models 116. During, prior to and/or after transition of the system 150 from one state to another 118, the engine 104 may generate a particular output computing event (120-1)-(120-n). For example, at the end of executing actions associated with state 118-1, an output computing event 120-1 may be generated. Similar to the input computing events, non-limiting examples of output computing events may include a query to retrieve data; a computing prompt indicating that execution of a particular computing call, function, routine, and/or procedure may be desired and/or needed; an application programming interface (API) call, function, routine, and/or procedure; a hypertext transfer protocol/secure (HTTP/HTTPS) communication; a representation state transfer (REST) communication; a session description protocol (SDP) communication; a JAVASCRIPT output, file, etc.; a JSON document, file, etc.; a graphical user interface output; a text output; a graphical output; an audio output; a video output; and/or any other communication, output, call, function, routine, procedure, etc. The events 120 may be other actions, data, etc. One output computing event 120 may serve as an input to for execution of another executable action. For instance, output computing event 120-1 may serve as an input computing event to actions associated with and/or that may be performed in connection system 150's state 118-2.

The engine 104 may execute actions using one or more containers. In some implementations, each action may be executed using its own container. A container may refer to a standard unit of software that may be configured to include the code that may be needed to execute the action along with all its dependencies. This may allow execution of actions to run quickly and reliably.

The processes performed by the engine 104 may be circular, e.g., one output computing event generated as a result of execution of one executable action may become an input computing event to execution of another executable action. As shown in FIG. 1b, an output computing event 120-n may serve as an input computing event to execution of actions associated with the initial state 118-1 of the system 150. As can be understood, any output computing event may serve as an input to execution of any action by the engine 104. Any previously executed actions may be executed again using newly received output computing events from other actions to generate an update to the output computing event that has be previously generated as a result of execution of that action. This process may continue until resolution of the initial input computing event has been received.

In some implementations, the actions 114 (either within a particular process flow and/or between process flows) may be configured to be executed in a particular sequential order. For example, execution of one action may require results of execution of another action. Thus, one or more actions may enter into a waiting and/or holding state, during which they await results of execution of other actions.

Moreover, some actions may require execution during a predetermined period of time. If such actions are not executed within such period of time, their execution afterwards may be prevented. This may cause execution of the entire process flow that incorporates this action to be aborted and execution of the process flow may be restarted. In some instances, each executable action may be associated with its own predetermined period of time during which the actions may need to be executed. The periods of time may differ from one another.

In some implementations, one or more actions may be associated with another predetermined period of time, only after expiration of which they may be executed. For example, the engine 104 may need to wait a predetermined period of time to execute an action, otherwise results of its execution may be deemed unreliable and/or invalid. This may be useful when execution of actions may need to await results of execution of another action in the task resolution pipeline.

As stated above, the engine 104 may be configured to be communicatively coupled to a plurality of tenant computing systems. Alternatively, or in addition, one or more tenant computing systems may be integrated with the engine 104 and may be configured to listen to events associated with the engine 104. Each such tenant computing system may be configured to integrated with the engine 104 for the purposes of performing of one or more process flows that may be related to resolution of various issues. Moreover, each tenant computing system does not need to incorporate its own engine 104, whereby a single engine 104 may be configured to address input computing events that may be particular to that tenant computing system. In some implementations, the current subject matter may be configured to define one or more common executable actions that the engine 104 may be configured to execute across all tenant computing systems. Alternatively, or in addition to, a separate set of executable actions may also be defined for each tenant computing system and its corresponding process flows. Such sets of actions may be different from one tenant computing system to another, where execution of sets of actions associated with one tenant computing system for another tenant computing system may result in errors and/or incorrect resolutions of issues.

In some implementations, the system 150 may be configured to allow users to view and/or interact with execution of process flows and/or corresponding action using the user interface component 108. The process flows may be displayed as state diagrams, charts, etc. Users may interact with such process flows in any desired way, e.g., by pausing, stopping, altering, etc. their execution, adding further information, responding to queries, issuing queries, etc.

In some implementations, one or more user interface components 117 may be used by one or more development and/or support systems, users, etc. to provide various support functionalities to the lifecycle engine 104. By way of non-limiting example, user interface components 117 may be used to create, generate and/or provide one or more process flows that may be implemented by the engine 104. The process flows may be relevant to specific input computing events, one or more manual tasks (e.g., that may be identified by the task component 110), one or more automated tasks (e.g., that may be identified by the task component 113), one or more process flow models (e.g., available from model component 116), and/or any other purposes.

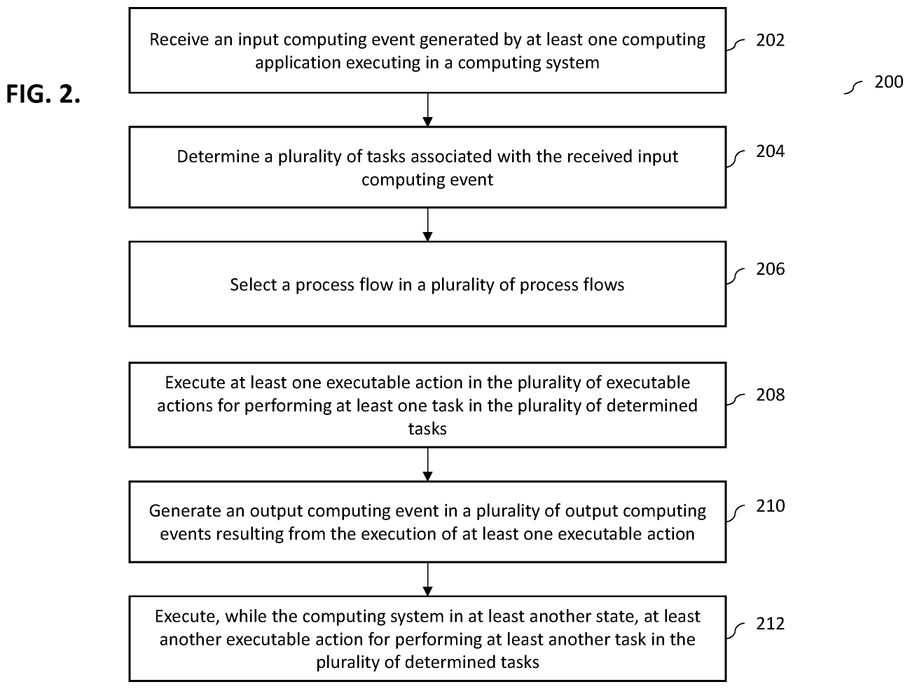

FIG. 2 illustrates an exemplary lifecycle orchestration process 200, according to some implementations of the current subject matter. The process 200 may be configured to be performed by the system 150 shown in FIG. 1b, and in particular by the engine 104. In some implementations, one or more tenant computing systems may be configured to execute one or more portions and/or the entire process 200. Execution of the process 200 may be performed in response to an input computing event, which may, in some instances, be related to a transaction (e.g., identification of irregularities, fraud, and/or any other issues, as in a case of a financial institution) that may be performed by one or more tenant computing system.

At 202, the engine 104 may be configured to receive an input computing event, which may be generated by at least one computing application executing in a computing system. Generation of the input computing event may be triggered as a result of query, request, etc. that may be received via one or more user devices 102, as shown in FIG. 1b.

At 204, the engine 104 may be configured to determine one or more or a plurality of tasks that may be associated with and/or may need to be performed in connection with the received input computing event. The tasks may be generated using the tasks component 110. The tasks may be specifically generated for a particular type of input computing event. The tasks may be generated and stored for later retrieval by the engine 104 in response to receiving the input computing event. Alternatively, or in addition to, the tasks may be dynamically generated in response to the receipt of such input computing event. Moreover, tasks may be generated during various states of the computing system and/or responsive to a particular output computing event. Further, tasks may be generated by task component 110 in response to the engine 104 generating a request to the task component 110 to create one or more tasks. The request from the engine 104 may be a result of an action that may have been triggered during a particular state 118 of a workflow.

At 206, the engine 104 may be configured to select a process flow (e.g., from a process flow component 112) that may need to be executed in response to the received input computing event. The process flow may have several steps that may need to be executed in order to resolve the issues associated with the input computing event.

Selection of the process flow(s) may be based on and/or associated with one or more models 116 for execution of such process flow(s). As discussed above, the models 116 may define one or more states 118 of the computing system during execution of each selected process flow as well as a plurality of executable actions 114 for accomplishing and/or performing the tasks that have been previously determined by the engine 104. The process flows 112 may be defined by various computing sources (e.g., federated computing sources), which may include developer computing systems that may generate such process flows in response particular types of computing events.

Moreover, execution of the actions may also involve obtaining data from one or more data storage locations, such as, for example, a database 108. The engine 104 may be configured to issue a query upon determining that various data may be required for execution of one or more process flows, executable actions, etc. Further, actions may be executed using one or more containers, which may include one or more microservices configured for execution of such actions. Each container may include requisite library of functionalities, data sources, etc. that may be needed for execution of each action. In some exemplary implementations, each actions may be executed using its own corresponding container. Alternatively, or in addition, one or more actions may be executed using one container. Containers may be communicatively coupled to one another using one or more communication networks.

At 208, once process flows have been appropriately identified, the engine 104 may be configured to execute the process flows to accomplish resolution of the received input computing event. Execution of the process flows may involve execution of executable action(s) identified in connection with the process flows. Execution of each action may be configured to perform at least one task that has been determined by the engine 104 for performing.

Moreover, as part of execution of executable actions in the process flows, the engine 104 may be configured to transfer the computing system from at least one state 118 (e.g., state 118-1) to at least another state (e.g., state 118-2). Completion of execution of executable actions associated with that state may be configured to generate an output computing event (e.g., state 118-1 may be configured to generate an output computing event 120-1), at 210.

Once the computing system has been transitioned from one state to another, at 212, the engine 104 may be configured to execute another executable action that may have been included as part of the determined process flows. As stated above, the output computing event generated as a result of a prior execution of an earlier action may serve as an input computing event to execution of one or more of subsequent executable actions.

In some implementations, the actions may be executed in a predetermined order (e.g., sequentially), simultaneously, and/or in any desired fashion. Further, actions may be executed within and/or after a predetermined period of time. Failure to execute a particular action within a particular period of time that may be defined for that action may result in prevention of execution of that action. In that case, the process flow and/or part of the process flow involving this action may be aborted and/or restarted. In some instances, the engine 104 may wait a predetermined period of time to execute a particular action, whereby an early execution of the action (i.e., prior to expiration of the predetermined period of time), may result in the process flow and/or part of the process flow involving that action to be aborted and/or restarted.

In some implementations, the engine 104 may be configured to transmit results of execution of one or more actions and/or data related to next actions to be executed to one or more interactive user interfaces 106. This information may be represented on the user interfaces using one or more state diagrams. User interfaces 106 may be used by one or more users to interact with execution of the process flows, modify execution pipelines associated with the process flows, actions, etc., submit additional information, terminate execution pipelines, etc.

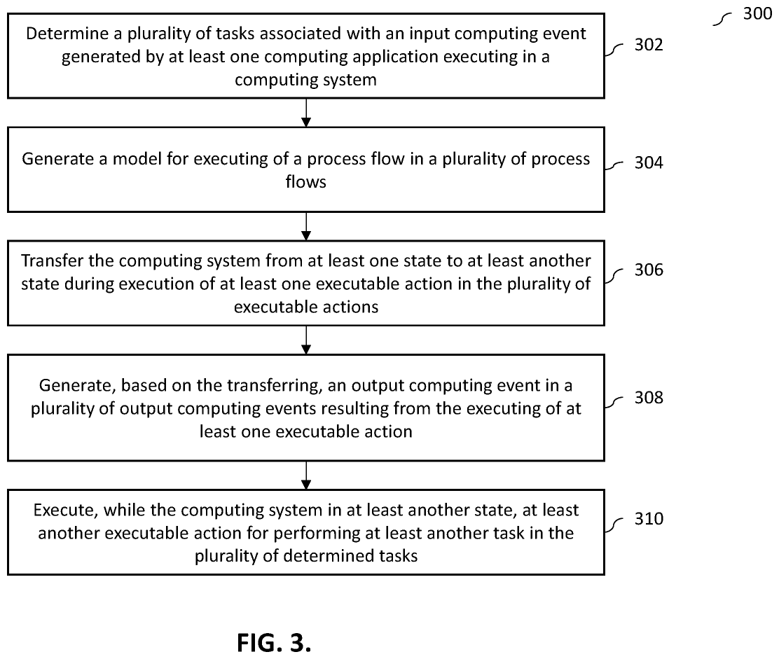

FIG. 3 illustrates an exemplary lifecycle orchestration process 300, according to some implementations of the current subject matter. Similar to process 200, the process 300 may be configured to be performed by the system 150 shown in FIG. 1b, including its engine 104. In some implementations, one or more tenant computing systems may also be configured to execute one or more portions and/or the entire process 300. Execution of the process 300 may likewise be performed in response to an input computing event (e.g., transactions irregularities, fraud, and/or any other issues, as in a case of a financial institution) that may be generated by one or more tenant computing system.

In some implementations, upon receiving an input computing event, the engine 104 may be configured to determine a plurality of tasks associated with the input computing event, at 302. As stated above, the input computing event may be generated by one or more computing applications that may be configured to be executed by one or more tenant computing systems.

At 304, the engine 104 may be configured to generate a model for execution of one or more process flows. The process flows may be configured to be used for resolution of the received input computing event. The process flows may be configured to be generated by one or more federated data sources. Each federated data source may be separate from at least another federated data source. Further, the process flow may define one or more executable actions for execution using a separate container.

In some implementations, the model generated be the engine 104 may be configured to define one or more states (e.g., states 118) of the computing system during execution of the process flow and a plurality of executable actions for performing one or more tasks that may need to be performed to resolve the input computing event. Further, the engine 104 may obtain various data from a storage location (e.g., database 108) for the purposes of execution of one or more executable actions.

The engine 104 may then be configured to initiate execution of the actions defined as part of the process flows. During execution of one or more actions, at 306, the engine 104 may be configured to transfer the computing system from at least one state (e.g., state 118-1) to at least another state (e.g., state 118-2). Execution of each action may be configured to generate an output computing event 120 (e.g., an output data, another action, etc.), at 308. One or more generated output computing events 120 may be configured to serve as input computing events to other executable actions that may be defined as part of the process flow. In some instances, the process flow may define which output computing events may serve as input computing events to which actions.

Moreover, one or more microservices may be associated with execution of one or more executable actions. Execution of such microservices may generate one or more output computing events. Generation of such output computing events may be performed synchronously, asynchronously, and/or in any desired fashion.

At 312, the engine 104 may be configured to execute at least another action in the process flow. Execution of such action may be designed for performing another task. One or more generated output computing event may serve as an input to the execution of such another action.

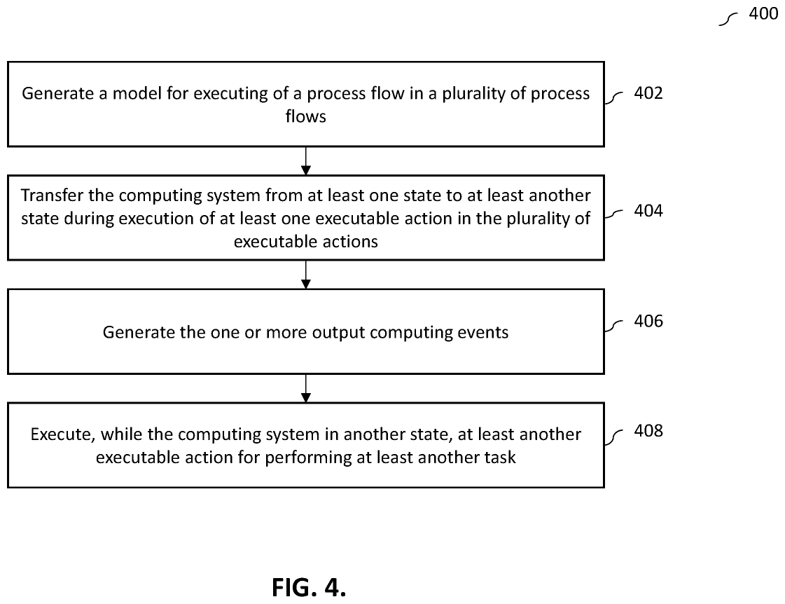

FIG. 4 illustrates yet another exemplary lifecycle orchestration process 400, according to some implementations of the current subject matter. Similar to processes 200 and 300 shown in FIGS. 2 and 3, respectively, the process 400 may be configured to be performed by the engine 104 of the system 150 shown in FIG. 1b. Tenant computing systems may be configured to be involved in execution of one or more portions and/or the entire process 400. A receipt of an input computing event (e.g., transactions irregularities, fraud, and/or any other issues, as in a case of a financial institution) may trigger execution of the process 400.

At 402, the engine 104 may be configured to generate a model for execution of one or more process flows. The model may define one or more states of a computing system during execution of the process flow and a plurality of executable actions for performing one or more tasks. The tasks may be directed to accomplishing various steps of the process flow to resolve the received input computing event.

Moreover, each state may be associated with execution of one or more microservices corresponding to executing of one or more executable actions in the plurality of executable actions. Execution of the microservices may be configured to generate one or more output computing events in a plurality of output computing events.

At 404, the engine 104 may transfer the computing system from at least one state to at least another state (e.g., state 118-1 to state 118-2) during execution of at least one executable action. At 406, the output computing events may be generated, and at 408, the engine 104 may execute at least another executable action for performing at least another task while in the next state (e.g., state 118-2). The generated output computing event may serve as an input to execution of at least another executable action.

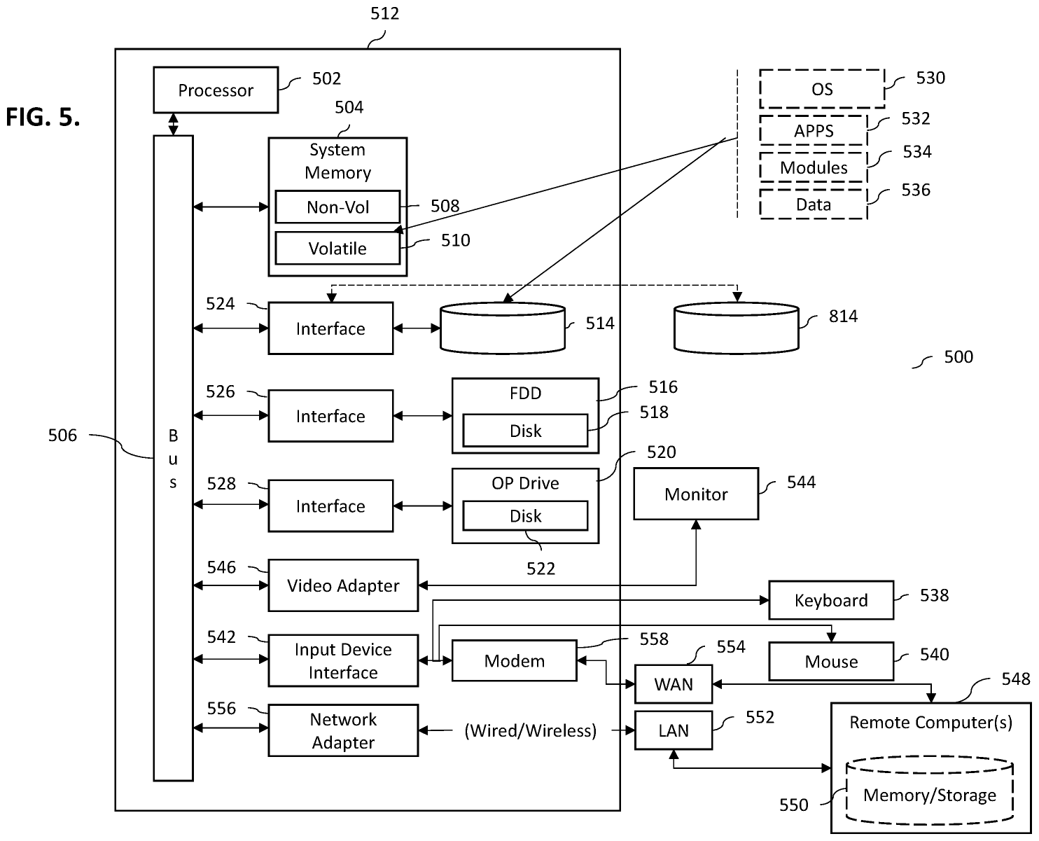

FIG. 5 illustrates an embodiment of an exemplary computer architecture 500 suitable for implementing various embodiments as previously described. In some implementations, the computer architecture 500 may include or be implemented as part of computing architecture 100 and/or system 150 shown in FIGS. 1a-b. In some implementations, the computing system 500 may be representative, for example, of the components 101-105 shown in FIG. 1a and/or engine 104, UI 106, database 108, and/or components 110-116 shown in FIG. 1b. As can be understood, these implementations are not limited in this context. More generally, the computing architecture 500 may be configured to implement all logic, applications, systems, methods, apparatuses, and functionality described herein with reference to FIGS. 1a-4 above.

As used in this application, the terms “system” and “component” are intended to refer to a computer-related entity, either hardware, a combination of hardware and software, software, or software in execution, examples of which are provided by the exemplary computing computer architecture 500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computer architecture 500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing computer architecture 500.

As shown in FIG. 5, the computer architecture 500 includes a computer 512 comprising a processor 502, a system memory 504 and a system bus 506. The processor 502 can be any of various commercially available processors. The computer 512 may be representative of at least one of the components 101-105 shown in FIG. 1a and/or engine 104, UI 106, database 108, and/or components 110-116 shown in FIG. 1b.

The system bus 506 provides an interface for system components including, but not limited to, the system memory 504 to the processor 502. The system bus 506 can be any of several types of bus structure that may further interconnect to a memory bus (with or without a memory controller), a peripheral bus, and a local bus using any of a variety of commercially available bus architectures. Interface adapters may connect to the system bus 506 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computer architecture 500 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 504 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 5, the system memory 504 can include non-volatile 508 and/or volatile 510. A basic input/output system (BIOS) can be stored in the non-volatile 508.

The computer 512 may include various types of computer-readable storage media in the form of one or more lower speed memory units, including an internal (or external) hard disk drive 514, a magnetic disk drive 516 to read from or write to a removable magnetic disk 518, and an optical disk drive 520 to read from or write to a removable optical disk 522 (e.g., a CD-ROM or DVD). The hard disk drive 514, magnetic disk drive 516 and optical disk drive 520 can be connected to the system bus 506 by an HDD interface 524, and FDD interface 526 and an optical disk drive interface 528, respectively. The HDD interface 524 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 508, and volatile 510, including an operating system 530, one or more applications 532, other program modules 534, and program data 536. In one embodiment, the one or more applications 532, other program modules 534, and program data 536 can include, for example, the various applications and/or components of the system 100.

A user can enter commands and information into the computer 512 through one or more wire/wireless input devices, for example, a keyboard 538 and a pointing device, such as a mouse 540. Other input devices may include microphones, infra-red (IR) remote controls, radio-frequency (RF) remote controls, game pads, stylus pens, card readers, dongles, fingerprint readers, gloves, graphics tablets, joysticks, keyboards, retina readers, touch screens (e.g., capacitive, resistive, etc.), trackballs, track pads, sensors, styluses, and the like. These and other input devices are often connected to the processor 502 through an input device interface 542 that is coupled to the system bus 506 but can be connected by other interfaces such as a parallel port, IEEE 1394 serial port, a game port, a USB port, an IR interface, and so forth.

A monitor 544 or other type of display device is also connected to the system bus 506 via an interface, such as a video adapter 546. The monitor 544 may be internal or external to the computer 512. In addition to the monitor 544, a computer typically includes other peripheral output devices, such as speakers, printers, and so forth.

The computer 512 may operate in a networked environment using logical connections via wire and/or wireless communications to one or more remote computers, such as a remote computer(s) 548. The remote computer(s) 548 can be a workstation, a server computer, a router, a personal computer, portable computer, microprocessor-based entertainment appliance, a peer device or other common network node, and typically includes many or all the elements described relative to the computer 512, although, for purposes of brevity, only a memory and/or storage device 550 is illustrated. The logical connections depicted include wire/wireless connectivity to a local area network 552 and/or larger networks, for example, a wide area network 554. Such LAN and WAN networking environments are commonplace in offices and companies, and facilitate enterprise-wide computer networks, such as intranets, all of which may connect to a global communications network, for example, the Internet.

When used in a local area network 552 networking environment, the computer 512 is connected to the local area network 552 through a wire and/or wireless communication network interface or network adapter 556. The network adapter 556 can facilitate wire and/or wireless communications to the local area network 552, which may also include a wireless access point disposed thereon for communicating with the wireless functionality of the network adapter 556.

When used in a wide area network 554 networking environment, the computer 512 can include a modem 558, or is connected to a communications server on the wide area network 554 or has other means for establishing communications over the wide area network 554, such as by way of the Internet. The modem 558, which can be internal or external and a wire and/or wireless device, connects to the system bus 506 via the input device interface 542. In a networked environment, program modules depicted relative to the computer 512, or portions thereof, can be stored in the remote memory and/or storage device 550. It will be appreciated that the network connections shown are exemplary and other means of establishing a communications link between the computers can be used.

The computer 512 is operable to communicate with wire and wireless devices or entities using the IEEE 502 family of standards, such as wireless devices operatively disposed in wireless communication (e.g., IEEE 502.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 502.11 (a, b, g, n, ac, ax, etc.) to provide secure, reliable, fast wireless connectivity. A Wi-Fi network can be used to connect computers to each other, to the Internet, and to wire networks (which use IEEE 502.3-related media and functions).

The various elements of the devices as previously described with reference to FIGS. 1a-4 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores”, may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

What is claimed:

1. A computer-implemented method, comprising:
receiving, using at least one processor, an input computing event generated by at least one computing application executing in a computing system;
determining, using the at least one processor, a plurality of tasks associated with the received input computing event;
selecting, using the at least one processor, a process flow in a plurality of process flows, the selecting being based on one or more models generated for execution of each process flow in the plurality of process flows, the one or more models defining one or more states of the computing system during execution of each process flow in the plurality of process flows and a plurality of executable actions for performing one or more tasks in the plurality of determined tasks, each process flow in the plurality of process flows being generated by at least one federated data source in a plurality of federated data sources;
executing, using the at least one processor, at least one executable action in the plurality of executable actions for performing at least one task in the plurality of determined tasks, the executing of the at least one executable action transferring the computing system from at least one state in the one or more states to at least another state in the one or more states;
generating, using the at least one processor, an output computing event in a plurality of output computing events resulting from the executing of the at least one executable action; and
executing, using the at least one processor, while the computing system in the at least another state, at least another executable action in the plurality of executable actions for performing at least another task in the plurality of determined tasks, the generated output computing event being input to the executing of the at least another executable action.

2. The method according to claim 1, further comprising
receiving, using the at least one processor, data from at least one database communicatively coupled with the computing system and associated with the executing of the at least one executable action; and
updating, using the at least one processor, the generated output computing event using the received data to generate an updated generated output computing event.

3. The method according to claim 2, wherein the updated generated output computing event being input to the executing of the at least another executable action.

4. The method according to claim 1, wherein the executing the at least one executable action includes executing the at least one executable action after a first predetermined period of time.

5. The method according to claim 4, wherein the executing the at least another executable action includes executing the at least another executable action after a second predetermined period of time, the second predetermined period of time being different from the first predetermined period of time.

6. The method according to claim 1, wherein the executing the at least one executable action includes preventing executing of the at least one executable action after a first predetermined period of time.

7. The method according to claim 1, further comprising executing, using the at least one processor, each executable action in the plurality of executable actions in a sequential order to perform all determined tasks in the plurality of determined tasks, wherein an output computing event generated by the executing of each executable action being input to each subsequent executable action in the plurality of executable actions.

8. The method according to claim 1, wherein each federated data source in the plurality of federated data sources being separate from other federated data sources in the plurality of federated data sources, and each executable action being executed using a separate container in a plurality of containers.

9. The method according to claim 1, wherein each state in the one or more states is associated with execution of one or more microservices corresponding to the executing of one or more executable actions in the plurality of executable actions.

10. The method according to claim 9, wherein the execution of the one or more microservices generate one or more output computing events in the plurality of output computing events.

11. The method according to claim 10, wherein the one or more output computing events are generated using at least one of the following: synchronous generation, asynchronous generation, and any combination thereof.

12. The method according to claim 1, wherein the computing system is a multi-tenant computing system having a plurality of tenant computing systems.

13. The method according to claim 12, wherein one or more executable actions in the plurality of executable actions are configured for executing for all tenant computing systems in the plurality of tenant computing systems.

14. The method according to claim 12, wherein one or more first executable actions in the plurality of executable actions are configured for executing for first tenant computing systems in the plurality of tenant computing systems, and one or more second executable actions in the plurality of executable actions are configured for executing for second tenant computing systems in the plurality of tenant computing systems, the one or more first executable actions being different from the one or more second executable actions.

15. The method according to claim 1, further comprising generating a user interface associated with at least one of the following: the executing of the one or more executable actions in the plurality of executable actions, displaying one or more output computing events in the plurality of output computing events, the selecting of one or more process flows in the plurality of process flows, altering one or more process flows in the plurality of process flows, and any combination thereof.

16. A system, comprising:
at least one processor; and
at least one non-transitory storage media storing instructions, that when executed by the at least one processor, cause the at least one processor to perform operations including
determining a plurality of tasks associated with an input computing event generated by at least one computing application executing in a computing system;
generating a model for executing of a process flow in a plurality of process flows, the model defining one or more states of the computing system during execution of the process flow and a plurality of executable actions for performing one or more tasks in the plurality of determined tasks;
transferring the computing system from at least one state in the one or more states to at least another state in the one or more states during execution of at least one executable action in the plurality of executable actions;
generating, based on the transferring, an output computing event in a plurality of output computing events resulting from the executing of the at least one executable action; and
executing, while the computing system in the at least another state, at least another executable action in the plurality of executable actions for performing at least another task in the plurality of determined tasks, the generated output computing event being input to the executing of the at least another executable action.

17. The system according to claim 16, wherein each process flow in the plurality of process flows being generated by at least one federated data source in a plurality of federated data sources, wherein each federated data source in the plurality of federated data sources being separate from other federated data sources in the plurality of federated data sources, and each executable action in the plurality of executable actions being executed using a separate container in a plurality of containers.

18. The system according to claim 16, wherein the operations further comprise
receiving data from at least one database communicatively coupled with the computing system and associated with the executing of the at least one executable action; and
updating the generated output computing event using the received data to generate an updated generated output computing event;
wherein the updated generated output computing event being input to the executing of the at least another executable action.

19. The system according to claim 16, wherein each state in the one or more states is associated with execution of one or more microservices corresponding to the executing of one or more executable actions in the plurality of executable actions, the execution of the one or more microservices generate one or more output computing events in the plurality of output computing events, wherein the one or more output computing events are generated using at least one of the following: synchronous generation, asynchronous generation, and any combination thereof.

20. At least one non-transitory storage media storing instructions that, when executed by at least one processor, cause the at least one processor to perform operations comprising:
generating a model for executing of a process flow in a plurality of process flows, the model defining one or more states of a computing system during execution of the process flow and a plurality of executable actions for performing one or more tasks in a plurality of determined tasks, each state in the one or more states is associated with execution of one or more microservices corresponding to executing of one or more executable actions in the plurality of executable actions, the execution of the one or more microservices generate one or more output computing events in a plurality of output computing events;
transferring the computing system from at least one state in the one or more states to at least another state in the one or more states during execution of at least one executable action in the plurality of executable actions;
generating the one or more output computing events; and
executing, while the computing system in the at least another state, at least another executable action in the plurality of executable actions for performing at least another task in the plurality of determined tasks, the generated output computing event being input to the executing of the at least another executable action.
